(19) United States
(12) Patent Application Publication
(10) Pub. No.: US 2021/0022507 A1
(43) Pub. Date: Jan. 28, 2021

(54) Automatic Shampoo Bowl/Massage Chair

(71) Applicant: Tameka Nicole Williams, Cleveland, OH (US)

(72) Inventor: Tameka Nicole Williams, Cleveland, OH (US)

(21) Appl. No.: 16/522,584

(22) Filed: Jul. 25, 2019

(51) Int. Cl. A47C 1/10; A47C 1/11; A45D 19/08

(52) U.S. Cl. CPC A47C 1/10; A45D 2019/005; A45D 19/08; A47C 1/11

(57) ABSTRACT

Automatic Shampoo Bow/Massage Chair consist of an shampoo bowl sink, automatic rubber holes to disperse shampoo/conditioner. On and Off control knobs, control box for the hands motion and speed, an water nozzle, neck rest to support your neck and also an massage chair for relaxation of the back muscle with massage and heating elements.

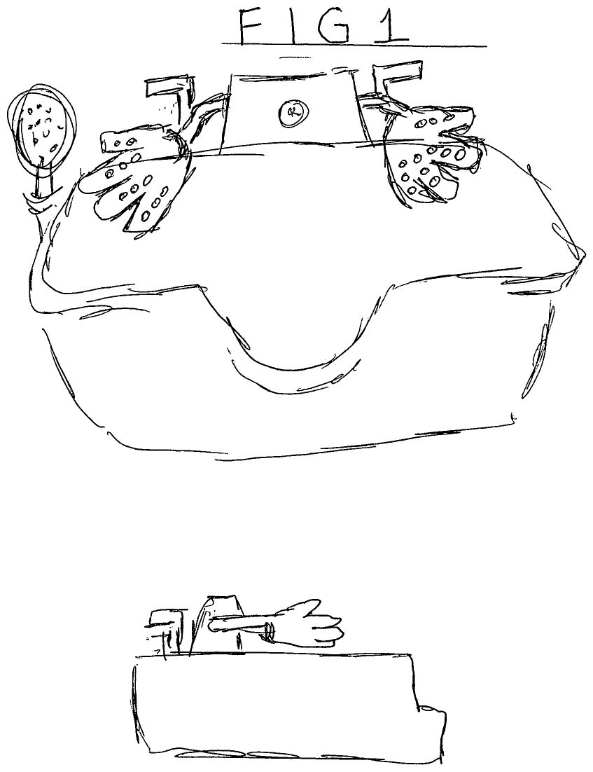

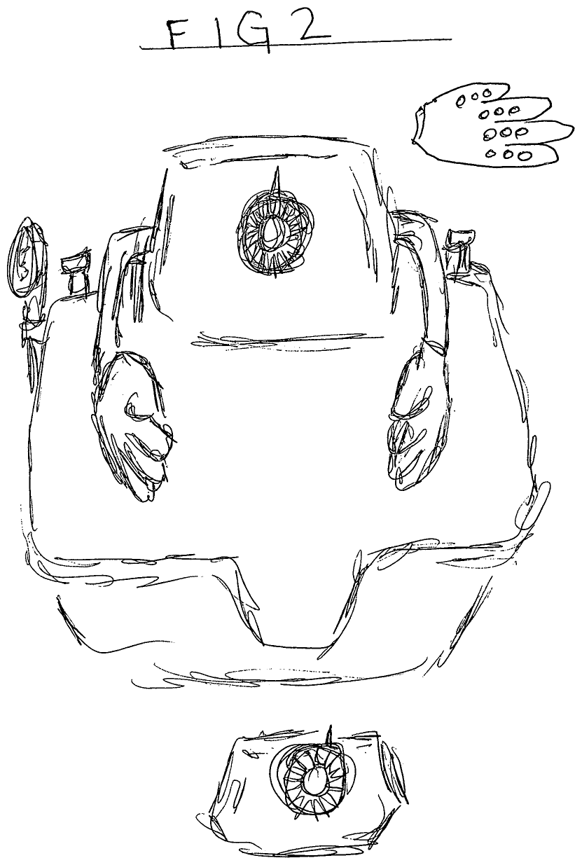

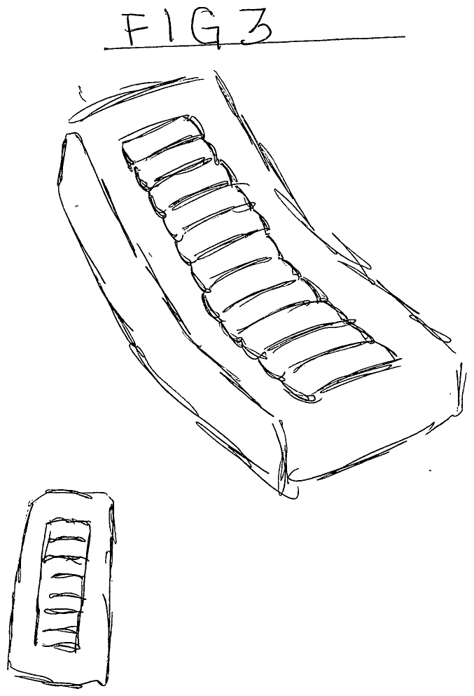

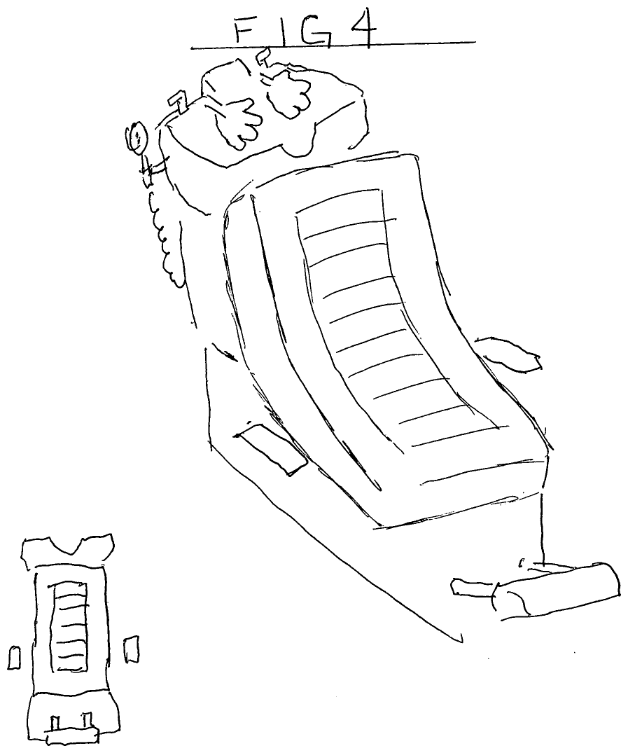

### INTRODUCTION

### Disclosure to InventHelp®

This Information Summary relates to a product idea called “AUTOMATIC SHAMPOO BOWL AND CHAIR” which has been disclosed to InventHelp® by Ms. Tameka Williams of Euclid, Ohio. This Information Summary is based upon information and disclosure forms submitted to InventHelp® by the originator along with notes from conversations with our InventHelp® sales representative. We have also supplied general marketing information tailored to “AUTOMATIC SHAMPOO BOWL AND CHAIR” and have made suggestions when appropriate. The result is a reference tool which can be used to submit “AUTOMATIC SHAMPOO BOWL AND CHAIR” to industry in a logical format which stresses its positive and most appealing features.

In preparing the Basic Information Package, we utilize standard statistical data with a heavy orientation on material prepared by the U.S. Department of Commerce and the Bureau of the Census. We attempt to supplement this data with more specialized information available from other basic marketing reference works, trade associations, trade publications, libraries, and other sources. The statistics provided in this report should not be interpreted as projections. Statistics generally lag two or more years behind the current year because of the time required by the various sources to compile and summarize the figures.

The completion of the Disclosure to InventHelp® and Record of Invention form documents the confidential disclosure of “AUTOMATIC SHAMPOO BOWL AND CHAIR” to InventHelp® on a given date and may help establish a record of origin and disclosure to others.

### DESCRIPTION

### Product Concept Review

In this Information Summary, we will review the distinctive features of the product idea and the needs it may fulfill. The concept of “AUTOMATIC SHAMPOO BOWL AND CHAIR”, as Ms. Williams submitted it to InventHelp®, is a combination shampoo bowl and hair salon chair that would automatically shampoo a person's hair. This product, if manufactured, could be used in salons, barbershops, nursing homes, spas, etc.

The “AUTOMATIC SHAMPOO BOWL AND CHAIR” would consist of an automatic shampooing system that would feature the following components: shampoo tank/bottle, bristles to release shampoo, automatic hands, water dispenser, massaging device (optional), and recliner (optional).

The “AUTOMATIC SHAMPOO BOWL AND CHAIR” would provide individuals with a neat, easier, and faster method of receiving shampooing services in salons and barbershops. It would eliminate waiting for a long period of time to shampoo hair. This unit could be offered in various sizes and colors.

### Function and Appealing Features

“AUTOMATIC SHAMPOO BOWL AND CHAIR” is being suggested by Ms. Williams because she believes it would fulfill the need for a more accurate-and timesaving means of receiving shampooing services in salons.

The appealing features of “AUTOMATIC SHAMPOO BOWL AND CHAIR” would be its all-in-one design, timesavings, energy-savings, convenience, ease of use, effectiveness, practicality, eye-catching and novel design, durability, adjustable design, and accuracy. This salon chair and shampoo bowl combination would automatically shampoo a client's hair. Stylists could perform other duties on other clients while the first client's hair was shampooed. Thus, it would save them time and effort on the job. A series of small holes in the hands would automatically dispense shampoo and water. The “AUTOMATIC SHAMPOO BOWL AND CHAIR” would enhance the client's comfort and improve efficiency while shampooing hair. This automatic machine could contribute to greater accuracy, precision, and ease in shampooing hair. This unit would provide the individual with a quick, convenient, and simple way to receive shampooing services. This unit would be easy to use, user-friendly, convenient, practical, adjustable, timesaving, durable, and versatile.

### Historical Development

Prior to contacting InventHelp®, Ms. Williams, who is employed as a cosmetologist, identified a need or a problem to be solved that prompted her into the invention process. She then conceived “AUTOMATIC SHAMPOO BOWL AND CHAIR”. Subsequently, sketches/drawings and a written description were prepared for review by InventHelp®. No attempts have been made to manufacture or market “AUTOMATIC SHAMPOO BOWL AND CHAIR”.

### PRODUCTION CONSIDERATIONS

InventHelp's work is based on the premise that the originator has predetermined that “AUTOMATIC SHAMPOO BOWL AND CHAIR” will work, function as designed, serve the intended purpose, and accomplish those objectives desired. Generally, we do not express an opinion regarding feasibility nor do we make projections regarding the success of an idea or concept as the elements involved in marketing are many and complex. However, in the case of “AUTOMATIC SHAMPOO BOWL AND CHAIR”, we note that since it would involve electrical wiring and circuitry, it is likely that approval would have to be obtained from Underwriters Laboratories (UL). UL approval involves the testing of prototype and/or production units primarily as relates to fire safety.

### Variations

The potential exists for varying the production of “AUTOMATIC SHAMPOO BOWL AND CHAIR” in ways which could make it more appealing to a wider range of end users. This could include producing “AUTOMATIC SHAMPOO BOWL AND CHAIR” of various colors and sizes.

The materials used to produce the “AUTOMATIC SHAMPOO BOWL AND CHAIR” could also vary.

The “AUTOMATIC SHAMPOO BOWL AND CHAIR” could also include optional massaging techniques.

### Producibility

It appears that “AUTOMATIC SHAMPOO BOWL AND CHAIR” could be produced easily using conventional and readily available materials and manufacturing processes. No new production technology would be required.

The chair could be formed from leather that would be cut, sewn, or otherwise stitched as desired. The bowl could be formed from ceramic, and kiln firing could be an approach to production.

The frame for the “AUTOMATIC SHAMPOO BOWL AND CHAIR” could be wrought from aluminum using one or more of the automated or semi-automated forging processes, such as hammer forging, drop forging, or press forging, to name a few. Prior to forging, the material may be processed first by a more basic process such as casting, rolling, and/or drawing. A manufacturer or forge operator would likely evaluate the form to determine the most efficient and effective forging processes to utilize.

Components produced from aluminum are most often an alloy of aluminum. Some elements commonly alloyed with aluminum are zinc, manganese, copper, silicon, and nickel and contribute variously to strength, corrosion resistance, hardness, specific gravity, and, on occasion, overall cost.

The “AUTOMATIC SHAMPOO BOWL AND CHAIR” would also feature rubber components.

The electronic circuitry for the “AUTOMATIC SHAMPOO BOWL AND CHAIR” would likely be printed integrated circuits with specific machine language code that would enable the product to function as desired as well as interface with standard, readily available components. Some standard components might be controls, the power supply, and display elements for the product. Comparable to program language for software, the machine language code for the circuitry could be developed by a manufacturer or contracted specialist.

### Cost Estimates

A wide range of factors influence the selling price, distribution channel markups, and unit cost of a product. The large number of variables and their fluctuations make it exceedingly difficult (if not impossible) to accurately estimate price, markups, and cost factors short of actual manufacture and distribution.

One common approach towards the selection of a possible selling price considers “positioning” of the proposed product relative to other existing products with similar attributes. Price positioning therefore is part of the overall market position and reflects a price which could be in line with the potential perceived value for the proposed product.

Once “price” or “perceived value” is estimated, consideration can then be given to what type of markup structure could reasonably be used to arrive at such a final selling price, given known or estimated markup correlations between retailers, wholesalers or distributors, and manufacturers. We use a retrospective approach and work with an estimated selling price to approximate wholesaler markups and manufacturing costs.

Manufacturers, in determining their prices, also consider such factors as fixed costs associated with plant, equipment, and tooling; factors such as the costs of raw materials, labor (affected by automation), assembly techniques, packaging, and overhead; and marketing variables such as the costs of shipping and handling, sales expenses, warranty and return factors, factors of loss, overhead, competitive pricing, geographic and demographic location, etc.

Within the scope of this Basic Information Package report, even the best efforts can result in deriving only rough approximations for the positioning of selling price, corresponding distributor channel markups, and potential manufacturing costs. For working purposes in preparing this Information Summary, however, we project an estimated pricing structure as follows:
Manufacturing Cost: $500.00 per unit
Wholesale Price: $1,000.00 per unit
Sales Price: $2,000.00 per unit

This pricing structure would vary greatly, depending on the size and style of the “AUTOMATIC SHAMPOO BOWL AND CHAIR”, as well as the materials used.

### Industrial Classification

There are firms that may be capable of manufacturing “AUTOMATIC SHAMPOO BOWL AND CHAIR”. InventHelp® uses the traditional Standard Industrial Classification (SIC) system developed by the U.S. Department of Commerce to structure their databases of manufacturers. Under the SIC system, each manufacturing category is assigned a numerical classification code. In preparing this Basic Information Package report, we designate manufacturers in a general category using a four-digit SIC code. The following represents the number of manufacturers classified in the broad category corresponding to “AUTOMATIC SHAMPOO BOWL AND CHAIR”:
4,299 Manufacturers of Electrical Machinery, Equipment, and Supplies, n.e.c. (SIC 3699)
1,175 Manufacturers of Leather Goods, n.e.c. (SIC3199)
154 Manufacturers of Vitreous China Plumbing Fixtures and China and Earthenware Fittings and Bathroom Accessories (SIC 3261)
3,159 Manufacturers of Fabricated Metal Products, n.e.c. (SIC 3499)
17,351 Manufacturing Industries, n.e.c. (SIC 3999)

Only a small percentage of these manufacturers may be appropriate candidates for the submission of “AUTOMATIC SHAMPOO BOWL AND CHAIR”. We use this SIC code to attempt to match your invention to companies registered in our Data Bank™ or with companies from general industry sources. In some cases, a more defined keyword will be used to narrow the broad SIC category down to a more specific area of interest. We attempt to match the SIC code or keywords assigned to your invention with corresponding areas of interest of companies in our Data Bank™. We also search for companies with matching or similar SIC codes from our database or general business sources. In addition, you may have knowledge of companies which you believe may be interested in your invention. We encourage your participation in the submission process and will attempt to submit your invention summary to companies you have designated. Generally, we strive to send submission materials to up to 100 companies.

In 1997, the U.S. Department of Commerce implemented a new classification system, the North American Industrial Classification System (NAICS), to replace its Standard Industrial Classification (SIC) system that had been in use for more than 60 years and was last revised in 1987. NAICS (pronounced “nakes”) was developed in conjunction with Canada and Mexico to more easily interpret and compare economic data among these allied trading partners. Although NAICS represents a more comprehensive way for the Department of Commerce to report economic statistics, both systems continue to be used.

### MARKET CONSIDERATIONS

### Competitive Environment

When considering the introduction of a new product to the marketplace, one of the factors that should be considered is the competitive environment. Efforts should be made to learn what existing competitors are offering to their customers and the customers' wants and needs. A new product introduction can be an improved or modified version of an existing product or it can be a totally new product innovation. In either case, the competitive environment should be studied to determine the existence of similar or identical products.

The inventor has disclosed a belief that this product concept is original; we have relied on this information when preparing this report. We conduct a necessarily limited check of the marketplace for competitive products. An in-depth investigation is not possible as there is no definite way to assure that an idea or product has not been tried or thought of in the past or is not now in use somewhere in our country or elsewhere. In addition, the competitive environment changes daily. Old products disappear; new ones appear. Seasonal trends also influence the availability of products. While a check of the marketplace may turn up nothing today, a similar product may already be produced and on its way to a distributor. A new product may even be on the drawing board in preparation of actual manufacture, and of course there would be no way for us to know of its existence. A competitive product may also be available within a specific geographical market area or available only on a limited basis as part of a test marketing program, so it is possible that neither the inventor nor InventHelp® would be able to locate competitive products.

In preparing our Basic Information Package reports, we generally review catalogs for the existence of similar products. In conducting such a spot-check for “AUTOMATIC SHAMPOO BOWL AND CHAIR”, we did not find an existing competitive product on the market.

### Benefits, Appeals, and Trends

Many factors influence the acceptance of a product in the marketplace. Two of the major factors relate to the needs a product fulfills (the benefits) and a desire to own that product (the appeal and/or a combination of these factors). Also important are the trends pertaining to the invention. Within this section of our Information Summary, we will consider the various benefits, appeals and trends which relate to “AUTOMATIC SHAMPOO BOWL AND CHAIR”.

The “AUTOMATIC SHAMPOO BOWL AND CHAIR” would offer individuals a more convenient , way to receive shampooing services in salons, barbershops, and nursing homes. This automatic shampooing machine would combine the functions of a salon chair and shampoo bowl. The client would simply sit in the chair. When activated, a set of hands would automatically shampoo and massage the head. Water and shampoo would be dispensed through a series of holes in the hands. The “AUTOMATIC SHAMPOO BOWL AND CHAIR” could be easily refilled when needed.

The “AUTOMATIC SHAMPOO BOWL AND CHAIR” would save stylists a considerable amount of time and energy on the job. They could perform other tasks while a client's hair was automatically shampooed, thus contributing to greater efficiency on the job. This machine would eliminate the task of manually shampooing clients' hair, which would also save stylists/barbers time and effort.

The “AUTOMATIC SHAMPOO BOWL AND CHAIR” would eliminate the hassle of waiting in a salon or barber shop for shampooing services. Instead, the client could receive this service within minutes with the use of the “AUTOMATIC SHAMPOO BOWL AND CHAIR”. It would be simple to use, effective, practical, convenient, user-friendly, eye-catching, adjustable, and reasonably priced. It could be produced in a multitude of shapes, styles, colors, sizes, and designs.

Barbers and cosmetologists, also called hairdressers and hairstylists, offer hair care services to enhance the appearance of consumers. Other personal appearance workers, such as manicurists and pedicurists, shampooers, and skin care specialists offer specialized services that assist clients in looking and feeling their best.

Barbers trim, cut, shampoo, and style hair. In addition, they apply hairpieces and provide scalp treatments and facial shaving. In many states, barbers are licensed to color, bleach, or highlight hair and to provide permanent-wave services. In addition, numerous barbers provide skin care and nail treatments.

Hairdressers, hairstylists, and cosmetologists provide beauty services, such as cutting, shampooing, styling, and coloring hair. They may counsel clients on how to care for their hair, how to straighten their hair or give it a permanent wave, or how to darken or lighten their hair color. Also, cosmetologists may be qualified to give manicures, pedicures, and scalp and facial treatments; provide makeup critiques; and clean and style wigs and hairpieces.

Many workers provide specialized services. Manicurists and pedicurists, called nail technicians in some states, work solely on nails and offer manicures, pedicures, coloring, and nail extensions to clients. Another group of specialists is skin care specialists, or estheticians, who beautify and cleanse the skin by providing facials, full-body treatments, and head and neck massages and by removing hair through waxing. Electrologists use an electrolysis machine to remove hair. Finally, in some larger salons, shampooers specialize in shampooing and conditioning hair.

As well as working with clients, personal appearance workers are expected to provide clean work areas and sanitize all their work instruments. They may make appointments and keep records of hair color and permanent-wave formulas utilized by their customary clients. An increasing number vigorously sell hair care products and other cosmetic supplies. Barbers, cosmetologists, and other personal appearance workers who handle their own salons have managerial duties that may embody hiring, supervising, and firing workers, as well as keeping business and inventory records, ordering supplies, and arranging for advertising.

Barbers, cosmetologists, and hairdressers held nearly 673,700 jobs in 2016. In 2018, the median hourly wage for barbers, cosmetologists, and hairdressers was $11.94 or $24,830 per year.

Most of these workers are employed in beauty salons or barber shops, but they also are found in nail salons, day and resort spas, department stores, nursing and other residential care homes, and drug and cosmetics stores. Nearly every town has a barbershop or beauty salon, but employment in this occupation is concentrated in the most populous cities and states.

Nearly half of all barbers, cosmetologists, and hairdressers were self-employed in 2018. Many own their own salon, but an increasing number lease booth space or a chair from the salon's owner.

Overall employment of barbers, cosmetologists, and hairdressers is projected to grow 13 percent from 2016 to 2026, faster than the average for all occupations.

### Market Targets

One of the most important factors to consider in the new product development process is the size of the potential market. For purposes of this report, a “market” is defined as the “set of potential purchasers” of a new product. While few products have universal appeal, it is possible to generally define a broad market to give an indication of its size. Since most products are targeted to specific groups of consumers with specialized interests, it is often possible to segment the market into submarkets. Each submarket differs in its requirements, buying habits, or other critical characteristics.

It is not our intention in this section to imply that all or even any of the markets identified would represent actual purchasers of “AUTOMATIC SHAMPOO BOWL AND CHAIR”. Our purpose is simply to identify those groups which we view as being appropriate potential market targets for the invention in the event that it is manufactured and marketed.

The Primary Market would consist of 595,390 individuals and companies in the beauty salon industry. According to the Census Bureau, 526,247 of these salon owners and self-employed individuals have businesses with no employees, that is, they are individual proprietorships, partnerships, or nonemployer businesses organized as corporations. Of the 69,143 beauty salons with employees, 68,234 operate at a single location. The 909 multi-unit companies operated at a total of 13,398 locations when the Economic Census (conducted every 5 years) was taken in 2007. The 122 largest chains—those operating at ten or more locations—accounted for 10,515 outlets that year, while the 210 companies operating at five to nine locations accounted for 1,360, as well as 99,053 barbers and barbershop businesses. According to the Census Bureau, 95,108 of these barbershop owners and self-employed barbers have businesses with no employees, that is, they are individual proprietorships, partnerships, or nonemployer businesses organized as corporations. Of the 3,945 barbershops with employees, 3,901 operate at a single location. The 44 multi-unit barbershop companies operated at a total of 392 locations when the Economic Census (conducted every 5 years) was taken in 2007. The six largest barbershop chains—those operating at ten or more locations—accounted for 254 outlets that year, while another 11 businesses operating at five to nine locations accounted for 69.

Also of interest could be the medical facilities market, including the administrators or managers of America's 5,564 hospitals. This total includes 4,862 community (non-federal acute care) hospitals, 212 federal government hospitals, 401 non-federal psychiatric hospitals, 79 non-federal long-term care facilities, and 10 hospital units of institutions (e.g., prison hospitals, college infirmaries).

Furthermore, in the United States, there are an estimated 12,400 home health agencies, 4,000 hospices, 15,600 nursing homes, and 30,200 residential care communities.

The Centers for Medicare and Medicaid Services report that there are 4,104 rural health clinics and 5,470 ambulatory surgical centers that are registered participants of the Medicare/Medicaid Services program.

According to the U.S. Bureau of Economic Analysis, American consumers spent $71.26 billion in hair salons and personal grooming establishments in

2016.

In addition to the Primary Market described above, the international market would represent a Secondary Market. Factors of language, cultures and standards of living would be important considerations when viewing the world market.

Many products today enjoy worldwide distribution. The interdependence of nations, growing import and export trade, and expanding common markets have all tended to draw our world closer together in both buying habits and product utilizations.

According to the International Trade Administration, U.S. exports of goods and services for 2015 were $754.2 billion, which was a 2.3 percent decrease from 2014. More than 304,000 U.S. companies exported goods in 2015. Nearly 98 percent of these companies were small- or medium-sized enterprises (SMEs) with fewer than 500 employees. One of the most popular export destinations for SMEs is Canada, with more than 90,000 registered export sales. Additionally, 21,000 SMEs exported to South Korea, more than 14,000 exported to Columbia, and about 93,000 exported goods to the European Union. The following export product groups represent the highest dollar value in American global shipments during 2015: machines, engines, pumps ($205.8 billion); electronic equipment ($169.8 billion); aircraft, spacecraft ($131.1 billion); vehicles ($127.1 billion); oil ($106.1 billion); medical, technical equipment ($83.4 billion); plastics ($60.3 billion); gems, precious metals, coins ($58.7 billion); pharmaceuticals ($47.3 billion); and organic chemicals ($38.8 billion).

According to the Foreign Trade Division of the Census Bureau, U.S. firms exported $7.22 billion worth of miscellaneous electrical equipment and components in 2014, an increase over exports in this category during 2013, which totaled $7.07 billion.

### Distribution Channels

Once the potential market targets for a new product have been identified, consideration should be given to identifying the types of outlets where the product could potentially be distributed to those market targets. In this section, we will identify potential channels of distribution for “AUTOMATIC SHAMPOO BOWL AND CHAIR”. However, there is absolutely no way that anyone can project with any accuracy the number of distribution outlets which might actually handle any given product.

In obtaining the number of outlets for a particular distribution channel, we utilize information from the Economic Census conducted by the Census Bureau, an agency within the U.S. Department of Commerce, as our primary source.

The following channels represent potential outlets where “AUTOMATIC SHAMPOO BOWL AND CHAIR” could be distributed:
Merchant Wholesalers of Beauty Shop & Barbers' Equipment & Supplies (with employees): 1,357
Merchant Wholesalers of Restaurant & Hotel Equipment & Supplies (with employees): 2,771
Merchant Wholesalers of Medical & Hospital Equipment & Supplies (with employees): 6,637
Beauty Salons: 474,367

Of particular interest within some general categories already suggested could be these more specialized potential outlets (as counted by a major business list firm):
Boutique Shops: 5,814

In today's global marketplace, products may be exported in a number of ways: directly by the manufacturer, by wholesalers, by retailers, or by other agents, to name a few. According to the Economic Census, nearly 7,190 merchant wholesalers (with employees) cite exporting to be the primary nature of their business. This number represents 3.2 percent of the total number of exporting establishments tracked by the Foreign Trade Division of the U.S. Commerce Department. Nevertheless, these exporters in addition to exporters included among the distribution channels previously cited may be of interest when considering distribution to the international market:
Wholesale Merchant Exporters of Miscellaneous
Durable Goods (with employees): 263

### Direct Business-to-Business Sales

The “AUTOMATIC SHAMPOO BOWL AND CHAIR” could be marketed by catalog, Internet commerce, and/or other direct marketing initiatives directed to business owners, managers, and purchasing executives. In general, business owners and managers expect marketing to be directed to them. Research has shown that business decision makers are more receptive to marketing proposals and are very engaged readers of any business-to-business media, general business magazines, television, and newspapers. On average, executives read more than four trade magazines each month and visit more than seven business-to-business (B2B) web sites. However, many executives, business leaders, and decision makers have embraced mobile access and recognize the capabilities these mobile devices have on their day to day business operations. Executives and decision makers are using their mobile devices both inside and outside the office to obtain business information, communicate, conduct business research, and make direct purchases of products and services from suppliers for their organizations.

Many executives prefer to use smartphones or tablets to conduct business transactions (including purchases) instead of personal computers (PCs). Smartphones are everywhere, but tablets are emerging as a device of choice for transacting business, according to Forbes. Most executives turn to mobile devices first when initiating the purchase process. In 2013, 87 percent used PCs, and 12 percent used mobile devices. It is forecasted that these statistics will rise to 40 percent of executives using PCs and 51 percent using mobile devices in 2016. In some leading corporations, PCs have already become almost pass in the executive suite. According to Forbes, seven of ten executives reported using smartphones or tablets to look up product and service information, and more than one-third of executives reference information from their mobile device when a business purchase needs to be made. This shift from PCs to mobile devices for business purchasing is imminent. Because many executives indicated they prefer to use their tablet or smartphone, suppliers need to make it easier to buy on a mobile device. Even though many executives have embraced mobile access, issues with mobile web sites or apps often prevent direct purchasing using the mobile device.

It is no secret a great deal of executives' time is spent outside their offices. There is a certain “immediacy factor” occurring in the business world today. The availability of mobile access has enabled them to extend their work time and workspace beyond a typical work day. An important use of mobile devices is during business trips (90 percent). Seventy-eight percent of executives use their mobile devices for business purposes at home, 70 percent while commuting, 71 percent while socializing for business, 66 percent in the office, 60 percent while watching TV, and 41 percent during exercising/recreation, according to Forbes. The availability of mobile apps and web sites for exploring new products or services speeds up the executive decision making process, thus giving them a competitive advantage.

The fast pace of today's world has vastly impacted the business world. However, the challenge is that many sites are not completely ready for the mobile age. Seventy-three percent of the executives participating in the Forbes survey state that a bad experience with many mobile web sites has made them less likely to do business with that particular supplier in the future. Hence, 61 percent state that a bad mobile experience led the executive to a competitor's site or app. The lack of a mobile friendly mobile interface is the main reason why the corporate decision makers could not use their mobile devices. More than one-third of executives surveyed stated too many of their suppliers' sites or interfaces were non-mobile optimized web sites or apps were hard to read, see, or navigate. Or the purchasing company indicated that their corporate purchasing system did not support mobile devices. Also, many mobile optimized sites do not allow the same functionality or options as the full PC web site, which decreases the user experience and limits the user's accessibility. A move to being a mobile company means much more than simple hardware changes. A full migration to successful mobile business means a new era of flexibility for all businesses.

Companies must thoroughly and successfully advertise their products to companies during the initial discovery phase; hence many are utilizing content marketing. By definition, content marketing is a marketing technique of creating and distributing valuable, relevant, and consistent content to attract and acquire a clearly defined audience with the objective of driving profitable customer action. B2B content marketers in the U.S. are making great strides, according to a survey by the Content Marketing Institute. Forty-two percent of executive content marketers consider themselves effective, which is an increase from 36 percent in 2013. Executive marketers are feeling more confident because more and more (44 percent) have a documented content strategy, plus a dedicated person who oversees content marketing strategy (86 percent). In 2014, 93 percent of B2B marketers stated they used content marketing.

B2B marketers are using social media much more frequently. Specifically, in 2014, it was reported that successful B2B marketers were using LinkedIn (91 percent), Twitter (85 percent), Facebook (81 percent), YouTube (73 percent), Google+ (55 percent), Slideshare (40 percent), Pinterest (34 percent), Instagram (22 percent), Vimeo (22 percent), Flickr (16 percent), StumbleUpon (15 percent), Foursquare (14 percent), Tumblr (14 percent), and Vine (14 percent). As the modern buying process continues to change and buyers conduct more pre-sale research online, social platforms have evolved into more than just a place to stay in touch with family and friends. According to the B2B “Content Marketing Benchmarks, Budgets & Trends Report”, 94 percent of B2B marketers used LinkedIn to distribute relevant content. LinkedIn is a network filled with 350 million business professionals, making this social site an extremely important resource for B2B companies looking to build their sales and online presence. According to the Weidert Group, LinkedIn is primarily used as a platform for businesses to promote their products and services, build credibility within their industry, and interact with B2B decision makers in a professional setting. LinkedIn is being used today to build quality relationships with business prospects and driving quality traffic to web sites.

Marketing budgets have changed significantly in the last 5 years. Marketing budgets at B2B companies were forecasted to rise 6 percent in 2014, according to Forrester Research. This amount is less than the 5 to 10 percent many companies had in place before the 2008 recession. B2B marketing budgets went down severely in 2009 and 2010. Budgets have inched up in recent years, and analysts do not believe they are anywhere close to where they were pre-2009 level. However, 61 percent of marketers expect to increase the proportion of technology spending versus the amount of spending on marketing communications/programs. Spending more on technology will allow companies to track their programs' return on investment and help marketers monitor the effectiveness of various company tactics and programs. According to Forrester Research, trade shows still constituted the biggest item in a B2B marketer's budget, with 20 percent being committed to live events in 2014. Many companies have a struggled relationship with physical events. As time goes on, many more companies will allocate company spending on local events, rather than big conferences and trade shows, according to Advertising Age.

Although business executives have been active online for years, and the great majority of vendors and manufacturers have web sites, much is still being ironed out and refined in the digital universe to improve product sales to the commercial market. Optimally designed B2B web sites have great potential to convert business users to customers and sales leads. However, in comparison to B2C web sites, B2B marketers face greater challenges in web site design because, according to the Nielsen Norman Group, products are more complex, the customers are more diverse, and the buying process has many more steps and complications. The growing industry of marketing professionals dedicated to maximizing returns on integrated, cross-media direct marketing strategies typically focus on web site design and functionality as a means of increasing sales leads and e-commerce transactions to the business market. According to the Weidert Group, by 2020, it's estimated that more than 80 percent of the buying process will occur online without direct human-to-human interaction. With so many transactions occurring online these days, companies will rely on their social buyer employees to find the best products, services, and deals. Social buyers know how to navigate the modern marketplace, therefore, companies trust them with larger budgets and much more responsibility.

Company web sites must be mobile friendly to make its online presence relevant, credible, and easy to navigate to maintain a competitive advantage. E-commerce is an investment in the future of every company and likely impacts every area of a B2B organization.

As previously noted, executives are becoming more and more mobilized, and it is up to B2B service companies and suppliers to meet this opportunity with web sites and mobile apps that will enable simple and seamless business transactions. Also key to B2B company success is to ensure that the right information is provided to the decision maker as early in the process as possible. For a majority of executives and their teams, mobile devices are powerful tools for gathering necessary information that leads to the purchasing decision. The ability to provide enhanced mobile experiences to business buyers means a competitive edge in today's fast paced global economy. This will require rethinking of the design of the mobile experience with a sharp eye toward simplicity and utility. It also means designing web sites and apps that perform well within small screen environments that support transactions at the speed of business. In the current marketplace, executives are constantly on the move, and their office is fluid. Mobile devices are the computing platforms of choice. The ability to access information easily and the ability to purchase products needs to be done at the touch of a button.

### PROMOTIONAL CONSIDERATIONS

Marketing a product involves more than development, pricing, and accessibility to the targeted markets. Any company attempting to market a new product is inevitably cast in the role of promoter. Potential customers must know that a new product exists, what its advantages are, and where it can be purchased.

InventHelp® is not the manufacturer or marketer. Many marketing organizations maintain in-house promotional staffs, while others purchase outside services from advertising agencies and public relations firms. In this Basic Information Package report, InventHelp® will suggest some means of promotion that could be considered by a potentially interested manufacturer or marketing organization.

### Advertising

One of the most widely used methods of promoting sales of a new product is advertising. Advertising can take many forms and involve varied media, including television, radio, magazines, newspapers, and outdoor displays. In general, advertising is a pervasive mode of communication which permits the advertiser to repeat a message many times.

An advertising posture for “AUTOMATIC SHAMPOO BOWL AND CHAIR” might involve the use of trade magazines. Some business (trade) publications to consider for the placement of advertising for “AUTOMATIC SHAMPOO BOWL AND CHAIR” include American Salon, American Spa, Salon Today, Modern Salon, Salon, and Skin Inc, as well as Hospitals & Health Networks, Modern Healthcare, Health Facilities Management, Healthcare Purchasing News, and Infection Control Today.

In addition, advertising in trade magazines oriented to import/export activities (such as Exporter, World Trade, and Commercial News USA) might be utilized.

### Online Promotion

The digital advertising landscape continues to evolve. Marketing executives face a diverse terrain that includes the relatively new and still maturing promotional tools of social media (Facebook, LinkedIn, and Twitter), blogs, and videos, as well as the longer established promotional tools of email marketing, click through display ads, and paid search.

Companies that advertise to a commercial market of business owners or managers know that they are pitching to

decision makers who typically prefer straightforward, efficient communication that respects their time and expertise.
More than ever, business customers demand a thorough demonstration of the value of the products and supplies they contemplate purchasing.

Some marketing experts would argue for making online promotional strategies the starting point for any advertising campaign for companies engaged in B2B sales, with the seller's web site serving as the centerpiece of the campaign. Marketing leaders report their most positive outlook in the economy since the recession occurred 6 years ago, according to the CMO

survey done in 2015. The level of optimism shown in the survey shows that 69.9 percent of business leaders are confident in the present economy, compared to 47.7 percent in February 2009. It is predicted that marketing budgets are expected to increase 8.7 percent in 2015, due to the increase in optimism of today's economy. According to the CMO survey, marketers are spending
their increased budgets on digital marketing, mobility, social media, and marketing analytics. This is expected to increase 11.7 percent in 3 years.

The Internet has given rise to new methods in the advertising world: inbound marketing and outbound marketing. The concept of inbound marketing, defined as “a methodology that focuses on creating quality content that pulls people toward your company and product” was first introduced by HubSpot as an ideal solution for cash-strapped entrepreneurs as well as for businesses seeking to maximize return on their ad spending. Inbound marketing campaigns are inherently more economical than outbound marketing campaigns in which sellers pay to push marketing messages out to a customer base. According to Hubspot, the percentage of marketers that practice inbound marketing is increasing year over year. Specifically, 60 percent of marketers practiced inbound marketing in 2013, compared to 85 percent in 2014. For the first time in the past 4 years, outbound marketing as a primary lead source has dropped sharply to 22 percent in 2014 from 34 percent in 2013. Meanwhile, inbound marketing has remained relatively stable, with 45 percent in 2014 (decrease of 1 percent) compared to 46 percent in 2013.

Since 2006, a similar methodology called “content marketing” has taken a strong stance in modern companies. By definition, content marketing is the process of continuously publishing content that people want (versus advertising that attempts to interrupt the content people want) to help connect the brand to its audience. Content marketing is becoming an effective way for brands to reach their audiences to get customers to know, like, and trust the company enough to purchase products. According to Newscred, 86 percent of television advertisements are skipped, 99.99 percent of banner ads are ignored, and U.S. newspapers have lost $40 billion in the last 10 years. Brands need a new way to connect with their business audiences. Nearly six of ten marketing professionals consider content marketing to be a subset of inbound marketing. Eighty-five percent of marketers state that the two concepts, inbound marketing and content marketing, are directly related. It is believed that business success relies on both concepts. Content, from a company blog, webinars, email nurturing, and customer videos for example, are important components to drive an inbound marketing engine. Inbound marketers produce greater results and enjoy having larger budgets, but without quality content, the inbound methodology stalls.

According to Hubspot's “State of Inbound 2014” report, “getting found” is priority #1. High performing companies are taking the time and effort to emphasize programs designed to make it easy to have their company and its content be easily located. Processes topping the list to accomplish this are blogging, organic searches, social media, SEOs, and content amplification. As mentioned above, more companies are running inbound strategies than ever before. These companies are measuring ROI and more are improving their ROI.

Inbound marketing tactics are expanding into other lines of business departments and are not just limited to marketing departments. According to Hubspot's survey, 25 percent of companies have infused inbound marketing in sales departments and 10 percent in their services department. Half of marketers across the B2B, B2C, and nonprofit sectors ranked inbound marketing as their primary lead source. Sales professionals are inherently much more “inbound” than are marketers who lean towards outbound marketing practices. The growth of inbound marketing has been increasing year after year.

Inbound marketing aligns more closely with the way today's purchasing decision makers actually use the Internet discover and research new products and to find the most competitive

vendors. Web savvy business customers have come to expect either a stand-alone web site or micro-site dedicated to the introduction of a new product in the marketplace, or (at the very least) sufficient content on the manufacturer's or distributor's web site to provide them with the information they need and with an easy way to connect to get questions answered.

B2B marketers are increasingly using social media in their business practices. According to the “Social Media Marketing Industry Report” survey done in 2012, over 93 percent of B2B companies use social media to market their businesses, compared to 88 percent of B2B marketers surveyed in 2010. In comparison, 95.2 percent of B2C companies used social media in 2012. Social media spending will increase to 20.9 percent by B2B product companies and will increase to 23.1 percent by B2B services companies in the next 5 years. B2B

companies utilizing social media state the following benefits: acquired new business partnerships (56 percent), had improved search rankings (60 percent), and were more able to gather marketplace insights from their social efforts (69 percent). Ninety-six percent of all B2C marketers use Facebook as a marketing tool, while 87 percent of B2B brands use Facebook as a social media medium. B2B marketers are more likely to use company blogs (65 percent) and Google+ (44 percent) and LinkedIn. It is important for companies to be able to measure the effect of social media marketing on their respective businesses. Businesses won't know results if they don't know how to measure their efforts.

There is great potential for versatile media to be incorporated into web sites to attract an audience, to communicate marketing messages, and to foster a positive impression. Throughout 2012, video marketing for B2B businesses showed an upward trend in both effectiveness and

popularity, and many industry experts expect this to continue in 2015 and beyond. Research firm Software Advice states in their “2012 B2B Demand Generation Benchmark Software Advice” survey that video was the second most popular type of content used across all channels. In another study from B2B Content Marketing, it was found that video had the largest increase of any content marketing tactic in 2012 (an increase to 70 percent from 54 percent in 2011). CMI's “B2B Content Marketing Report” also states that a significant majority of B2B marketers (58 percent) believes that video is an effective form of B2B marketing. Another report conducted by Brightcove, CMI, and MarketingProfs shows the popularity of video content as a lead generator and as a vehicle for building brand visibility. Seventy-six percent of those surveyed responded that video was the core factor in their digital marketing strategy. The report stressed that video is one of the most important factors in strategic content marketing. In 2014, 72 percent of B2B marketers used YouTube to publish video content. Seventy percent of B2B marketers created more content than they did in 2013. Forty-two percent of marketers confirmed they publish new content multiple times per week or daily, and brand awareness and lead generation were the top reasons for creating video content. According to the survey, after LinkedIn, Twitter, and Facebook, 72 percent of business marketers confirmed that YouTube was the video platform of choice to distribute content for lead generation and brand visibility purposes.

Over the years, as businesses expand into new marketing categories, new technologies are constantly being adopted to support the new approaches, and systems need to be in place to measure successes. Measuring marketing effectiveness has always been a challenge, as 57 percent of marketers state that measurement, analysis, and learning is a challenge in their business. Many companies use Web Analytics to measure things a webmaster cares about, such as page load times, page views per visit, and time on a particular business site. This type of measurement is mainly concerned with just the effectiveness of the website. It is believed that this type of measurement is not enough as it is only a snapshot in time. Also important in the quest to measure the success of a company's online presence is Marketing Analytics. Marketing Analytics measures business metrics like web traffic, leads, sales, and which events (both on and off the website) influence whether or not leads become business customers. Marketing Analytics not only analyzes data from the business website, but from other sources such as social media, email and offline events. Marketing Analytics considers all marketing efforts across all channels over a span of time, which is paramount for smart decision making and effective business program execution. With Marketing Analytics, marketers are able to identify and analyze how each of their initiatives (social media, blogging, email marketing) are performing, can measure the ROI of their activities, and understand how well the business is achieving their business goals, not just measuring their website with web analytics. Without the ability to test and evaluate the success of a business marketing program, there is no way to know what is working, what is not, when/if processes need changed, or how it needs changed.

To be most effective in today's consumer-centric selling environment, marketing experts also suggest that a company should use its web site and social media efforts to go beyond the sales talk and actively engage with their customers. Companies who listen to and work with their customers that use their resources for two-way communications to analyze and respond to comments, questions, and complaints are in a better position to build support for their product(s) and their brand through effective customer relationship management (CRM).

Despite the challenge in gauging return-on-investment (ROI)

for all positive aspects of social media marketing and quality content like blogs and video among purchasers of mass market goods, most firms have a sense it is worthwhile and plan to spend accordingly. If a company is running an inbound marketing program and not tracking ROI, a disservice is being done to the company. Inbound marketers who measure ROI are more than 12 times more likely to generate a greater ROI. Proving that a company is increasing return is very important for several reasons, most notably on the company's budget. Improving ROI could even protect the budget against factors beyond the company's control, such as the economy.

### Special Promotional Programs

In addition to the modes of promotion already suggested, a manufacturer or marketer may elect to promote a new product by displaying it at trade shows. Specifically, “AUTOMATIC SHAMPOO BOWL AND CHAIR” could be displayed at new product trade shows. Direct sales could also be used for promoting “AUTOMATIC SHAMPOO BOWL AND CHAIR”.

### SUMMARY

InventHelp® performs its services in two stages. In the first stage, we begin the packaging of your idea, invention, or product by assembling basic information about “AUTOMATIC SHAMPOO BOWL AND CHAIR” in a professional and attractive form. This report completes our Basic Information Package service to you.

You now have several alternatives to consider. One option would be to stop at this stage and do nothing further with “AUTOMATIC SHAMPOO BOWL AND CHAIR”. However, you would not be taking any steps to attempt to gain interest in your idea.

Another option would be to use your report to try to stimulate interest in or as a basis to further promote or develop “AUTOMATIC SHAMPOO BOWL AND CHAIR”. While having information about your idea in an organized report is helpful, we find that most inventors who approach us recognize that they do not have the time, expertise, or inclination to work on their ideas on their own.

A third option would be for you to move on to the second stage of submitting “AUTOMATIC SHAMPOO BOWL AND CHAIR” to industry through InventHelp®. If you purchase InventHelp's Submission Services, we can attempt to submit your idea to industry in the hope of obtaining a good faith review. We believe the submission of a new product idea to industry is best performed by an experienced company, and this is the role that InventHelp® can perform for you.

### How InventHelp® Can Assist You Further:

Professional Presentation: We are an experienced company that will create a professional presentation for your invention based on the information you provide to us. Information from your Basic Information Package will be used as a reference tool in the final packaging of “AUTOMATIC SHAMPOO BOWL AND CHAIR” for submission to industry during this phase of our services.
Submission to Companies: InventHelp® has many unique approaches in trying to submit our clients' ideas to industry. These include the use of the InventHelp® Data Bank and other industry databases, our Virtual Invention Browsing Experience (VIBE), publicity efforts, virtual invention presentations and other creative methods.
Patent Application: If you are interested in filing a patent application with the United States Patent and Trademark Office and you do not want to locate a patent attorney on your own, you may request that InventHelp® refer you to a patent attorney to whom we refer our clients' patent work. Because of the volume of work that we refer to patent attorneys, they are able to offer these patent services to our clients at a low cost and a flat fee.
Licensing: Our sister company, Intromark, Inc., is a licensing company that employs a number of licensing representatives. If a company expresses substantial interest in a client's invention, then an Intromark representative will follow up with the company to attempt to license the invention on the inventor's behalf.

Whichever option you choose, your Basic Information Package will serve as a convenient reference tool for your invention. Thank you for selecting InventHelp® to provide this service for you. We hope you are satisfied with our work and will now proceed to our second stage, the InventHelp® Submission Service. If you are interested in having our company submit your idea to industry, we suggest you consider the following InventHelp® services:
Submission Agreement
Virtual Invention Browsing Experience (VIBE)
Prototype Model
Patent Application Services based upon your patent attorney's recommendation

We look forward to working with you in submitting “AUTOMATIC SHAMPOO BOWL AND CHAIR” to industry.

### BIBLIOGRAPHY

Statistical Abstract of the United States: 2010 (129th Edition). U.S. Department of Commerce, Economics and Statistics Administration, U.S. Census Bureau, 2009.

“U.S. Export Fact Sheet,” International Trade Administration, www.trade.gov, released Jun. 3, 2015.

“United States Top 10 Exports,” www.worldstopexports.com, Mar. 10, 2016.

American Hospital Association. AHA Hospital Statistics, 2017. http://www.aha.org/research/rc/stat-studies/Pie-charts2017.shtml

National Center for Health Statistics, Centers for Disease Control and Prevention, US Department of Health and Human Services. Long-Term Care Providers and Services Users in the United States: Data From the National Study of Long-Term Care Providers, 2013-2014, February 2016. https://www.cdc.gov/nchs/data/series/sr_03/sr03_038.pdf

Centers for Medicare and Medicaid Services, US Department of Health and Human Services. 2016 CMS Statistics Reference Booklet. https://www.cms.gov/Research-Statistics-Data-and-Systems/Statistics-Trends-and-Reports/CMS-Statistics-Reference-Booklet/2016.html

National Center for Health Statistics, Centers for Disease Control and Prevention, US Department of Health and Human Services. Health, United States, 2015: With Special Feature on Racial and Ethnic Health Disparities, May 2016. https://www.cdc.gov/nchs/data/hus/hus15.pdf

“The Connected Executive,” Forbes Insights, www.forbes.com, March 2013.

“Executives Now Use Mobile Devices For Large Business Purchases, Survey Find,” Forbes, www.forbes.com, Jul. 2, 2013.

“B2B Marketing Budgets Set to Rise 6% in 2014: Spending Still Trails Pre-Recession Levels,” Advertising Age, www.adage.com, January 21, 2014.

“6 Reasons Why Every B2B Company Needs a LinkedIn Company Page in 2015,” Weidert Group, www.weidert.com, Mar. 20, 2015.

“B2B Content Marketing Benchmarks, Budgets and Trends—North America,” Content Marketing Institute Marketing Profs, www.iab.net, 2014.

“Personal Consumption Expenditures by Type of Product, Underlying Detail Table” (Table 2.4.5U), U.S. Department of Commerce, Bureau of Economic Analysis, Mar. 31, 2017. www.bea.doc.gov/, April 2017.

“State of Inbound Marketing 2014,” HubSpot, Inc., Cambridge, Mass., 2014. www.hubspot.com/, April 2015.

“Marketing Analytics—What it is and Why it Matters,” SAS, Cary, N.C., www.sas.com, accessed Apr. 9, 2015.

“Where Marketers Go to Grow,” HubSport, Inc., Cambridge, Mass., Mar. 8, 2012.

“How B2B Marketers Use Social Media: New Research,” www.socialmediaexaminer.com, Apr. 24, 2012.

“Strong Economic Outlook Spurs Marketing Spending,” www.forbes.com, Feb. 17, 2015.

“CMO Survey Report: Highlights and Insights,” CMOsurvey.org, February 2015.

“B2B Marketing Insider; Michael Brenner on Content Marketing, Strategy and Social,” www.b2bmarketinginsider.com, Accessed Apr. 13, 2015.

“How to Use Video Content to Drive Awareness, Leads, and Sales: A Guide,” Content Marketing Institute, www.contentmarketinginstitute.com, Apr. 26, 2013.

“76% of B2B Marketers Use Video Content Marketing, YouTube Top Choice,” Reelseo, www.reelseo.com, Oct. 1, 2014.

“U.S. International Trade Statistics: Value of Exports by Six-Digit NAICS, 2009-2010” (extracted table), U.S. Census Bureau, Foreign Trade Division, www.census.gov/, June 2011.

2007 Nonemployer Statistics (Geographic Area Series): Nonemplover Statistics for the U.S., States, Metropolitan Areas, and Counties. U.S. Department of Commerce, Economics and Statistics Administration, U.S. Census Bureau, Data finalized Jul. 21, 2009, extracted Jan. 17, 2011. www.census.gov/, January 2011.

2007 Economic Census: Other Services Except Public Administration (Subject Series), Establishment and Firm Size: Single Unit and Multiunit Firms for the United States. U.S. Department of Commerce, Economics and Statistics Administration; U.S. Census Bureau, Data finalized Dec. 7, 2010, extracted May 4, 2011. www.census.gov/, May 2011.

“Barbers, Hairdressers, and Cosmetologists,” Occupational Outlook Handbook, 2017-18 Edition.

What is claimed is:

1. Shampoo equipment for automatic shampooing of the hair and scalp/massage chair
a. shampoo bowl having plastic bars on the left and right side on two rubber hands (refillable) with tiny holes on the left and right hand for water dispersement and shampoo.

2. Shampoo equipment according to claim 1
wherein said to have hand controller knob at the top middle section of shampoo bowl and to control the firmness or speed of the hands and U shaped head rest to relax the neck in the middle of the bowl.

3. The invention where in said in claim 2 has an extension water sprout on left side of shampoo bowl just in case extra water is needed to rinse manually with a line connected to bowl so that water can pass through.

4. The invention where in said in claim 3 should have an knob on left back side of the bowl to control the reverberation of the motion of the hands to fast or slow with a know in the middle to turn hands on/off while on the right back of the bowl with an knob controlling the pressure firm/light (soft).

5. The invention has an chair with massage coils #8 for back relaxation for sprain muscles, back spasms, etc. heating (optional) on the left and right side of the chair will be arm rest to support left and right arm while receiving shampoo from the Automatic Shampoo Bowl/Massage Chair.
